(19) United States
(12) Patent Application Publication
(10) Pub. No.: US 2009/0050336 A1
(43) Pub. Date: Feb. 26, 2009

(54) Directly used pad for the arch of a shod hoof of an animal

(76) Inventor: Joseph Vaillant, Cluses (FR)

Correspondence Address: Fay Sharpe LLP, 1228 Euclid Avenue, 5th Floor, The Halle Building, Cleveland, OH, 44115-1843, US

(21) Appl. No.: 11/661,882

(22) PCT Filed: Sep. 2, 2005
(86) PCT No.: PCT/FR2005/002234

§ 371 Date: Jun. 2, 2008

(30) Foreign Application Priority Data
Sep. 3, 2004 (FR) 0409322

(51) Int. Cl. A01L 7/02

(52) U.S. Cl. 168/26

(57) ABSTRACT

A pad for the plantar arch of a shod hoof of an animal is characterized in that the pad is made of a synthetic material whose hardness/durometer ranges from 5 to 25 Shore A.

The present invention relates to a pad for the plantar arch for the shod hoof of animals, and more particularly to a horseshoe, intended in particular for equestrian sport.

The animals shod and used in sporting contests have their hooves shod with metal or synthetic protections with a separation plate placed between shoe and the hoof. These plates are generally shock-absorbing plates which are made out of a flexible material or a combination of materials intended to absorb the shocks which could damage the legs of the horse.

In addition, the plantar arch (called the sole) is generally filled using various castable products on the spot in order to isolate this zone from any intrusion by foreign bodies. These products are generally pastes or cements having a drying time which can exceed 24 hours.

All the materials used traditionally are of an unknown hardness, incompatible with desired comfort and their drying time is too long are also quite incompatible with the requirements of the modern life, which requires that the horse be available immediately, and the equine podologists and shoeing marshals do not today prescribe, castable materials with controlled hardness and fast drying specific to this application, except for support applications more used on farms in particular for orthopedic needs.

The patent application FR, 0409322 in this manner proposed a material used for the realization of the plantar pad of a Shore A hardness (durometer) ranging between 10 and 20 Shore A hardness, which makes it possible to obtain a plantar pad having good mechanical properties for a great number of arches of the shod hoof of animals.

However, for certain extreme configurations of the arches, it would be attractive to improve the comfort/damping compromise of the pad established between the shoeing pad and the sole. Indeed, certain hooves of animals have an extremely thin thickness horn on the side of the sole making the latter particularly sensitive and the pads already proposed are likely to increase compressions on the sole dangerously. Other hooves presenting a very pronounced depth of the plantar arch such that it presents openings at the back of the hoof or more prominent gaps than normal. On the occasion of certain movements for example during a sporting exercise of the animal particularly calling the hoof into action, the pads already proposed can leave these gaps and this, in spite of the presence of a separation plate.

Moreover, it would be attractive to improve the durability of the pads already proposed. Indeed, some sporting exercise involves intense stamping movements of hoof at a great rate, which transmits very strong mechanical shocks to the pads already proposed. This wear which is thus imposed on each type of pad already proposed, can lead this last to fracture and to break up by the back of the hoof.

A first goal of the invention is then to propose a pad for the plantar arch which allows, even with plantar arches with the extreme configurations referenced above, to have a better comfort/damping compromise.

Another goal of the invention is then to propose a solution to obtain a pad for any type of plantar arch which has a better durability.

To this end, the invention has as an aim a pad for the plantar arch for the shod hoof of an animal, characterized in that the pad is of synthetic material having a final hardness ranging between 5 and 25 Shores.

By final hardness, it is necessary to understand here and within the framework of the invention the hardened pad having already filled the space between the shoeing pad and the sole.

According to another characteristic, the pad has a tensile strength of at least 2.5 MPa and/or a tear strength of at least 12 kN/m.

According to another characteristic, the pad of plantar arch presents for a tensile strength of at least 2.5 MPa, an elongation at fracture at least equal to 450%.

Other characteristics and advantages will arise on reading the detailed description in reference to the following examples:

It is specified here that the tensile strength and elongation have been measured according to the ASTM D412 standard and the tear strength according to the ASTM D624 standard.

For each of the examples, a silicone was selected so that its drying time lies between 3 and 15 minutes. Thanks to this drying time, the operator in charge of the making the pad can realize carefully done work, while the speed of drying which is particularly short, allows a quasi immediate use of the shod animal, which makes it possible for the operator to be able to appreciate the effectiveness of the product immediately after his work.

Also for each of the following examples, the material used is a silicone made up of two components, a base and a hardener, which must be mixed right before use, and whose drying time lies between 3 and 15 minutes, such as for example 5 minutes.

The method for making each example of the pad includes in the following steps:

According to a first step, the operator proceeds to the mixing of the base and the hardener, such as for example by means of a syringe with a double compartment to make a pre-proportioning of the two components.

According to a second step, the material made according to the first step is put in for example an injection gun.

According to a third step, the operator experienced with the injection of material between the sole and the shoeing pad and this as well by the back of the hoof which presents openings opening this part of the hoof towards exterior (central or collateral grooves), that is to say by injection holes bored in the shoeing pad for this purpose. The viscosity of the product in this “working time” phase allows a natural molding by gravity, without the need for pressure.

According to a fourth step, the operator carries out the drying of material. It will be noted that the immobilization of the hoof thus filled with its pad is at least reduced thanks to the very fast drying time. During this operation, drying (curing) occurs instantaneously in a chemically neutral way, without volumetric modification and exothermic action. Thus, the immobilization of the hoof filled with its pad is reduced to a minimum, thanks to a drying time ranging between 3 and 15 minutes, and for example 5 minutes.

### EXAMPLE 1

### According to the Teaching of the patent FR 0409322

Pad made out of silicone presenting the following mechanical characteristics:

Shore A hardness: 10

Tensile strength in MPa: 1.4

Elongation at fracture: 350%

Tear strength in kN/m: 4

### EXAMPLE 2

### According to the Teaching of the patent FR 0409322

Pad made out of silicone presenting the following mechanical characteristics:

Shore A hardness: 18

Tensile strength in MPa: 1.6

Elongation at fracture: 230%

Tear strength in kN/m: 4.8

### EXAMPLE 3

Pad made out of silicone presenting the following mechanical characteristics:

Shore A hardness: 10

Tensile strength in MPa: 3

Elongation at Fracture: 550%

Tear strength in kN/m: 15

### EXAMPLE 4

Pad made out of silicone presenting the following mechanical characteristics:

Shore A hardness: 18

Tensile strength in MPa: 4

Elongation at Fracture: 500%

Tear strength in kN/m: 15

### EXAMPLE 5

Pad made out of silicone presenting the following mechanical characteristics:

Shore A hardness: 5

Tensile strength in MPa: 2.5

Elongation at Fracture: 500%

Tear strength in kN/m: 12

### EXAMPLE 6

Pad made out of silicone presenting the following mechanical characteristics:

Shore A hardness: 25

Tensile strength in MPa: 4

Elongation at Fracture: 450%

Tear strength in kN/m: 15

It was noted that:
for pads according to examples 1 and 2, subjected to movements of hooves at normal rate for a horse, comfort and damping were completely acceptable;
for pads according to examples 1 and 2, subjected to some intense sporting exercise with movements of hoof at a great rate, on the one hand an accelerated wear which sometimes leads to their fracture and their breaking up by the back of the shod hoof and on the other hand respectively a too accentuated compression on the level of the sole of hooves with very thin horn and material escaping by the back of the hoof;
for the pad according to example 3, the comfort of hoof for the plantar arch with an extremely thin sole was improved;
for the pad according to example 4, a better compressive strength was obtained;
for the pads according to examples 3, 4, 5, 6, an appreciable increase in the mechanical resistances to stretching and tearing led better durability.

One understood that thanks to the characteristics of material used, namely its hardness, its consistency and its structure, the pads thus formed participate fully in the damping of the shocks in the phase of posing the hoof, as with the distribution of the pressures on the hoof which is strenuously called out in particular during the sporting exercises.

One understood that the pad realized with claimed material fully fulfilled the role of filling to avoid any intrusion of a foreign body between the sole and the shoeing pad, and the method for making allows one to put it in a standard or individualized form. It also makes it possible to distribute the pressures in an ideal way, while drying is immediate with unrestricted cutaneous contact. One will also add that the cutaneous contact is allowed, thanks to the chemical neutrality of the material, and this without any risk, nor preliminary precautions.

Of course, the invention is not limited to the embodiments described and represented by way of examples, but it includes also all the technical equivalents as well as their combinations.

1. A pad for the plantar arch for a shod hoof of an animal, comprising:
synthetic material having a hardness ranging between 5 and 25 Shore A.

2. The pad for the plantar arch according to claim 1, wherein the pad has at least one of a tensile strength of at least 2.5 MPa and a tear strength of at least 12 kN/m.

3. The pad for the plantar arch according to claim 2, wherein it has a tensile strength of at least 2.5 MPa, and an elongation at fracture of at least equal to 450%.

4. The pad for the plantar arch according to claim 1, wherein the material has drying time between 3 and 15 minutes.

5. The pad for the plantar arch according to claim 4, wherein the material is made up of a base and a hardener.

6. The pad for the plantar arch according to claim 5, wherein the material is a silicone.

7. A method for making the pad according to claim 1, including:
in a first steps, mixing a base and a hardener.

8. The method for making the pad according to claim 7, further including:
in a second steps putting the material made according to the first step in an injection gun.

9. The method for making the pad according to claim 8, further including:
in a third step, injecting the material between a sole of the hoof and a shoeing pad at a back of the hoof which presents openings opening towards exterior (central or collateral grooves), or by holes in the shoeing pad intended for this purpose.

10. The method for making the pad according to claim 9, further including:
in a fourth step, drying the material.

11. A material for forming a pad for the plantar arch of a shod hoof of an animal comprising:
a synthetic material having a Shore A hardness between 5 and 25.

12. The material according to claim 11, wherein the synthetic material includes a silicon with the following properties:
a tensile strength of at least 2.5 MPa,
a tear strength of at least 12 kN/m,
an elongation at fracture of at least 450%, and
a drying time under 15 minutes.

13. A pad for the planar arch made of the material of claim 12.

14. A method for making the pad for the plantar arch of a shod hoof, comprising:
injecting the synthetic material of claim 12 between a sole of the shod hoof and a shoeing pad, and
allowing the synthetic material to cure.
